(19) United States
(12) Patent Application Publication
(10) Pub. No.: US 2008/0068521 A1
(43) Pub. Date: Mar. 20, 2008

(54) ELECTRO-OPTICAL GLARE PROTECTION FILTER AND GLARE PROTECTION UNIT FOR A PORTABLE GLARE PROTECTION DEVICE

(75) Inventor: Kaspar Cottier, Jona (CH)

Correspondence Address: RANKIN, HILL & CLARK LLP, 38210 Glenn Avenue, WILLOUGHBY, OH, 44094-7808, US

(73) Assignee: SPERIAN WELDING PROTECTION AG, Wattwil (CH)

(21) Appl. No.: 11/857,059

(22) Filed: Sep. 18, 2007

(30) Foreign Application Priority Data
Sep. 19, 2006 (CH) 1490/06

(51) Int. Cl. G02F 1/133

(52) U.S. Cl. 349/14

(57) ABSTRACT

An electro-optical glare protection filter for e.g. a protective mask for welding comprises at least two successively arranged liquid crystal cells (20, 30) of the type “twisted nematic” (TN) with polarization layers (21, 25, 31, 35), wherein the polarization directions of two respective polarization layers (21, 25, 31, 35), which are allocated to a liquid crystal cell (20, 30) are respectively twisted in relation to one another.

Hereby the polarization directions of two respective polarization layers (21, 25, 31, 35), which are allocated to a liquid crystal cell (20, 30) are uncrossed, i.e. twisted by an angle different to 90° in relation to one another.

### BACKGROUND OF THE INVENTION

1. Field of the Invention

The invention relates to the field of glare protection, such as is used e.g. in protective masks or protective helmets for welders and in particular to an electro-optical glare protection filter as well as a glare protection unit for a portable glare protection device.

2. Prior Art

Glare protection units for portable glare protection devices such as protective masks and protective goggles are generally known. Modern glare protection devices comprise electro-optical filters, e.g. with a liquid crystal element, the transmissibility of which is adapted automatically or manually. This kind of filter is, besides possessing a predetermined and optionally adjustable protection level, to be as little dependent as possible on the viewing angle.

WO 2004/102265 has the object to achieve a symmetrical dependency on angle of view in relation to the perpendicular to the LCD-element of a glare protection filter. The dependency on angle of view is ascribed to the birefringence in the LCD-cell. It is compensated by using a negatively birefringent compensation layer. For an optimal effect the parameters of the cell and the compensation layer must be matched to each other and the cell must be an HT (highly twisted) cell and if possible only let a single mode of light pass.

U.S. Pat. No. 5,515,186 describes a protective mask for welders with arrangements of polarizers, which are matched to each other such that a region, which appears to be brighter in a combination of two polarizers, appears to be obscured again in combination with a further polarizer. The liquid crystal cells are specifically of a type, which functions on the principle of switchable birefringence, as opposed to “twisted nematic” or TN cells, in which the polarization is switched. According to U.S. Pat. No. 5,515,186 a polarization angle other than 90° may be chosen, in order to compensate a residual birefringence, such that a maximal contrast is achieved at an angle of view perpendicular to the cells.

U.S. Pat. No. 6,327,010 shows an optical filter with a TN liquid crystal cell and a compensation layer of different liquid crystals. The whole filter comprises only one or two polarization layers. The arrangement is designed for application in LCD displays. High values for contrast and/or luminance and/or the independence of angle of view from contrast and/or color are to be achieved. In one embodiment this is achieved by means of providing two polarizers in a liquid crystal cell, which are twisted in relation to one another by 90°±10°, the angles between the polarizers and the rubbing directions of the TN cell meeting predetermined conditions, and at least one compensation layer for compensation of differences in the optical path of the liquid crystal cell is present.

WO 95/29428 shows a glare protection filter with a combination of two liquid crystal cells in a mutually twisted arrangement, wherein the two liquid crystal cells are respectively arranged between two mutually obliterating polarization filters. The liquid crystal cells hereby consist of low twisted nematic (LTN) cells, as e.g. disclosed in FR 2728358, U.S. Pat. No. 4,952,030 and U.S. Pat. No. 4,609,255.

WO 97/15255 describes one single or two liquid crystal cells, the polarizers of which are arranged to mutually extinguish one another, that is, to be in perpendicular to one another respectively. For reducing the dependence on angle of view a retarder film is arranged between two of the polarizers.

WO 99/53367 shows a configuration for one single liquid crystal cell of a display. The cell comprises—in the following order—a first polarizer, a first compensator again consisting of two layers, a liquid crystal layer, a second (two-layer) compensator and a second polarizer. The two polarizers are not mutually crossed but mutually twisted with relation to a crossed position by 2° to 6° or 20°, preferably by the same angle as the two polarizers.

### BRIEF SUMMARY OF THE INVENTION

It is thus object of the invention to create an electro-optical glare protection filter and glare protection unit for a portable glare protection device of the kind initially mentioned, which comprises a low dependency on angle of view and a simple design.

The electro-optical glare protection filter comprises at least two liquid crystal cells arranged in succession (in the direction of the normals of the filter planes) of the type “twisted nematic” (TN) with polarization layers, wherein the polarization directions of two respective polarization layers, which are respectively allocated to one liquid crystal cell, are not respectively parallel, i.e. are mutually twisted by at least 45°. The filter further comprises an controlling device for electrical control of the liquid crystal cells. Hereby the polarization directions of two polarization layers, which are respectively allocated to a liquid crystal cell, are not crossed, i.e. mutually twisted by an angle different from 90°.

With this kind of arrangement the dependence on angle of view of the darkening of the filter is reduced over a large region of the angle of view. Hereby no additional elements of the filters are required, in particular no additional retarder layers or compensation layers are required, but merely the identical components as with a conventional double cell. This leads to a simple and cost-efficient design.

In a preferred embodiment of the invention, the glare protection comprises at least two liquid crystal cells, wherein in precisely two of these liquid crystal cells the polarization directions of the two polarization layers, which are allocated to the respective liquid crystal cells, are not crossed, that is, uncrossed.

In a further preferred embodiment of the invention, in the cell or cells which feature uncrossed polarizers, the angle between
the bisecting line of the acute angle between the polarization directions of the uncrossed polarizers and
the bisecting line of the allocated liquid crystal layer are less than 45°. Hereby the bisectors of the associated liquid crystal layer respectively coincide with the bisectors between the orientations of the two orientation layers of the liquid crystal layer.

In a further preferred embodiment of the invention, the two liquid crystal cells are designed to be at least approximately mirror images of each other. Preferably they use the identical type of liquid crystals. Thus the symmetry of the dependence on view angle in relation to the surface normal is improved. The plane of symmetry lies in the spatial middle of the two liquid crystal cells. If the cells share the middle polarizer, the plane of symmetry is in the middle of this polarizer. If the cells comprise own respective, separated polarizers in the middle of the glare protection filter, the plane of symmetry is in the middle between these separated polarizers.

The angle of twist between the polarizer directions of two respective uncrossed polarization layers is preferably 82° to 89°, especially 85° to 88°, wherein the acute angle between the polarization directions is considered.

In a preferred embodiment of the invention the bisector of the acute angle between the polarization directions of two uncrossed polarizers preferably coincides with the bisector of the associated liquid crystal layer.

With the arrangement according to the invention, double cells may be created, which comprise a distinctively smaller variation of protection level (shade number SN) within a cone of view of an apex angle of 60° (i.e. deviating from the surface normal of the filter by 30° in each direction) than conventional filters based on TN cells.

In a preferred embodiment of the invention, the control unit for controlling the liquid crystal cells comprises a non-linear element in order to compensate for a non-linear voltage-darkening ratio of the liquid crystal cells. The non-linearity is preferably arranged at the end of the part of the control unit that determines the final control value and is thus—in the signal flow path—arranged ahead of the non-linearity of the cells.

A glare protection unit for a portable glare protection device comprises an electro-optical glare protection filter according to the invention.

Further preferred embodiments follow from the dependent claims. Hereby the characteristics of the method claims may correspondingly be combined to the device claims and vice versa.

### BRIEF DESCRIPTION OF THE DRAWINGS

In the following the object of the invention is explained in more detail by means of preferred exemplified embodiments, which are represented in the enclosed drawings. In a schematic manner:

FIG. 1 shows a protective mask with a glare protection cartridge;

FIG. 2 shows a layer succession of a liquid crystal cell;

FIGS. 3, 4, 5 show top views of a liquid crystal cell for demonstration of the orientations of its elements;

FIGS. 6-7 show layer successions of double liquid crystal cells;

FIGS. 8-9 show top views of double liquid crystal cells for demonstration of the orientations of their elements; and

FIG. 10 shows a trajectory of a voltage-darkening dependence.

The reference numbers used in the drawings and their references are listed in the reference list. In the figures similar parts are in principle designated with identical reference numbers.

### DETAILED DESCRIPTION OF THE INVENTION

FIG. 1 shows a protective welding mask 4 for with a glare protection cartridge 1. The glare protection cartridge 1 is arranged to be replaceable behind an also replaceable protecting shield 3. The glare protection cartridge 1 comprises an electro-optical filter 2, also called shutter. The filter 2 is controlled by control electronics 5 (not visible in FIG. 1). The electronics 5 is preferably fed by a battery and/or a solar cell. The control preferably occurs according to a quantity of light, which is detected by sensors on the front side of the glare protection cartridge 1. Hereby preferably a flicker circuit is used for detecting the arc load of welding processes, such that when a welding process occurs the filter 2 is obscured. The darkening may only be switched on and off, but the extent of darkening may also be controlled, e.g. by measure of the ambient light intensity, the intensity of the arc load, a user presetting, etc.

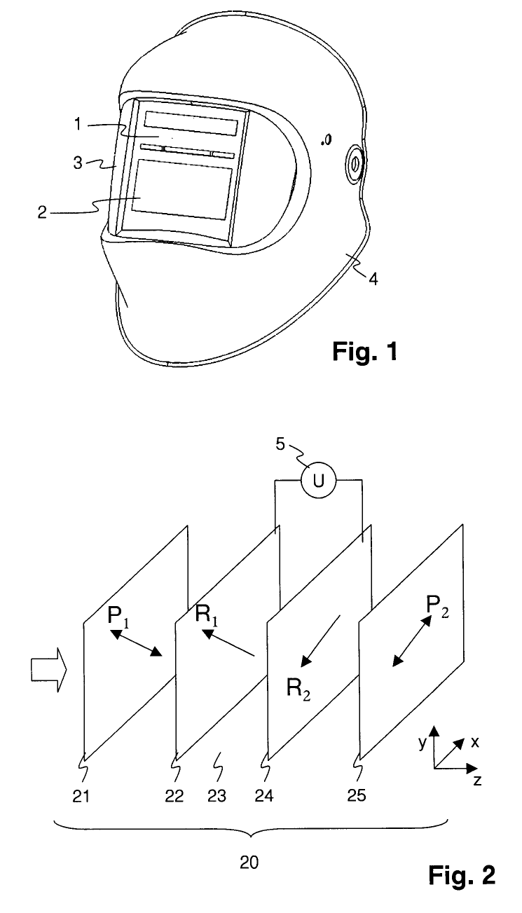

FIG. 2 shows a layer succession of a liquid crystal cell 20. Light, indicated by a block arrow, falls onto the cell 20 in the direction of a z-axis. The different layers of the cell 20 extend in respective planes in parallel to x- and y-directions. The liquid crystal cell 20 comprises, when viewed in the direction of the entering light, a first polarizer 21 followed by a substrate with a first orientation layer 22 and a second orientation layer 24. The orientation layers, in known manner, provide the basis for orientation of the liquid molecules on the border to the respective substrate. Between the orientation layers 22, 24 is an interspace with a liquid layer 23. Adjacent to the second orientation layer 24 a second polarizer 25 is arranged. The two substrates 22, 24 are designed as electrodes for control into the liquid crystal layer 23 and are electrically connected to the controlling electronics 5 and may be controlled by these.

The characteristic orientations of the polarizers and orientation layers are indicated by arrows. The directions of the first and the second orientation layers 22, 24 are denominated R1 and R2. The substrates are again located between polarizers. The polarization directions of the first and the second polarization layers 21, 25 are orientated along the directions P1 and P2.

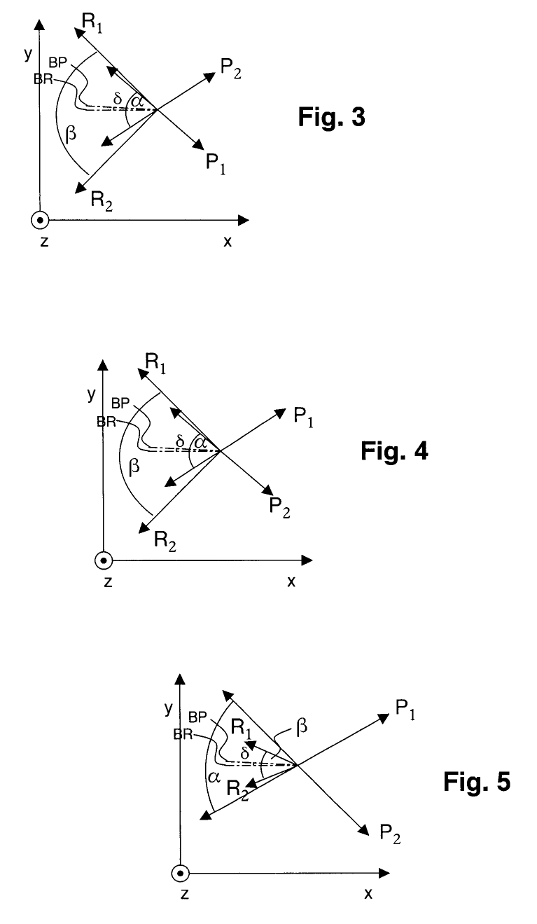

FIGS. 3, 4 and 5 show the directions of the polarization and orientation layers of the liquid crystal cell 20 in a projection onto the x/y plane. The mutual twist of the polarization directions P1, P2 is denominated α. Hereby the angle is defined as the smaller of the two possible twist angles and thus may be maximally 90°. The mutual twist of the orientation directions R1, R2 is denominated β and is also called “twist” of the liquid crystal cell 20.

In a conventional protective filter for welding the angle between the polarization directions is α=90°. These are normally called crossed or mutually extinguishing polarizers. With this arrangement a maximal darkening is achieved, when the liquid crystal cell is in an activated condition, i.e. the molecules are arranged approximately vertically and light falls through the liquid crystal cell without substantially changing its polarization.

By means of an specific uncrossing of the polarizers, such that e.g. 82°<α<89°, a different dependency on angle of view of the individual cell results. Hereby, in the direction, which is usually called “best viewing direction” , the darkening is amplified, typically distanced from the surface normal in an angle region between 5° and 45°. If a cell formed in this manner is combined according to the invention with a second liquid crystal cell, the amplified obscuring of the first cell compensates the areas with attenuated darkening of the second cell and vice versa. On the whole the darkening—measured over a predetermined angle of view—is more balanced than with a conventional configuration of the double cell with crossed polarizers. The maximally achievable contrast is reduced by means of uncrossing, which, however is not objectionable in as much as the usual maximal protection level of 13 of a protecting mask for welding may easily be achieved. On the contrary this reduced maximal contrast even results in a further advantage as distracting regions with too intense darkening are eliminated.

FIG. 3 shows a configuration of a preferred embodiment of the liquid crystal cell 20 according to the invention basing on a TN-cell with β=90°, in which the orientations of the polarizers are at least approximately parallel to the ones or the respective adjacent orientation layers (denominated as “P-buffed” in the following). The bisector of twist angle β is denominated BR, the bisector of the twist of the polarizers α is denominated BP. The angle between the two bisectors is denominated δ. In the preferred embodiment of the invention the angle between the bisectors is small e.g. δ<45°, or the bisectors are even at least approximately parallel, e.g. in the region of 0°<δ<20°.

A further preferred embodiment is shown in FIG. 4, in which the X-buffed configuration was chosen, i.e. in which the orientations of the polarizers are at least approximately perpendicular to those of the respective adjacent orientation layers.

FIG. 5 shows a further embodiment in the X-buffed configuration, in which a low twisted nematic cell with β<85° is used.

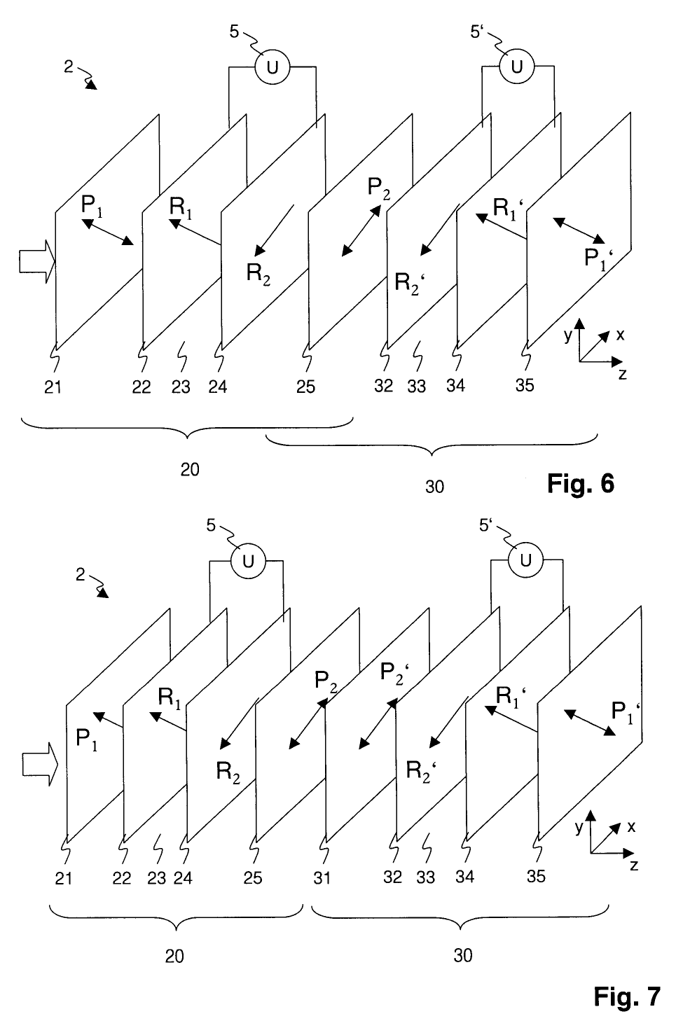

FIG. 6 shows a further layer succession of a double liquid crystal cell, wherein the first liquid crystal cell 20 as well as a second liquid crystal cell 30 are uncrossed. The second liquid crystal cell 30 shares the second polarizer 25 with the first liquid crystal cell 20 and for this purpose comprises further substrates with a third orientation layer 32 and with a fourth orientation layer 34, between which a second interspace or gap with a liquid crystal layer 33 is located. A third polarizer 35 is arranged subsequently to the fourth orientation layer 34. The two substrates 32, 34 are designed as electrodes for control of the second liquid crystal layer 33 and are electrically connected to the control electronics 5 or to a further control electronics 5′ and controllable through these.

In the P-buffed-cell shown in FIG. 6, P1 and R1 are additionally substantially parallel as well as also P2 and R2. In an X-buffed cell (not shown) P1 and R1 as well as P2 and R2 would be substantially perpendicular to each other.

The arrangement of the two cells is thus that they are mirror images of each other and the two liquid crystal cells are filled with liquid crystal of differing chirality. The plane of symmetry is in the middle between the two cells, that is, in the middle of the mutual polarizer 25.

FIG. 7 shows a layer succession of a double liquid crystal cell in a different preferred embodiment of the invention. Hereby the second polarizer 25 is not shared by both cells 20, 30 but the second liquid crystal cell 30 comprises a further middle (or a fourth) polarizer 31, which is arranged between the second polarizer 25 and the third orientation layer 32. The fourth polarizer 31 comprises an orientation P2′, which is substantially parallel to orientation P2. The two cells 20, 30 may thus be manufactured and tested separately from each other and only then be combined to form a double cell.

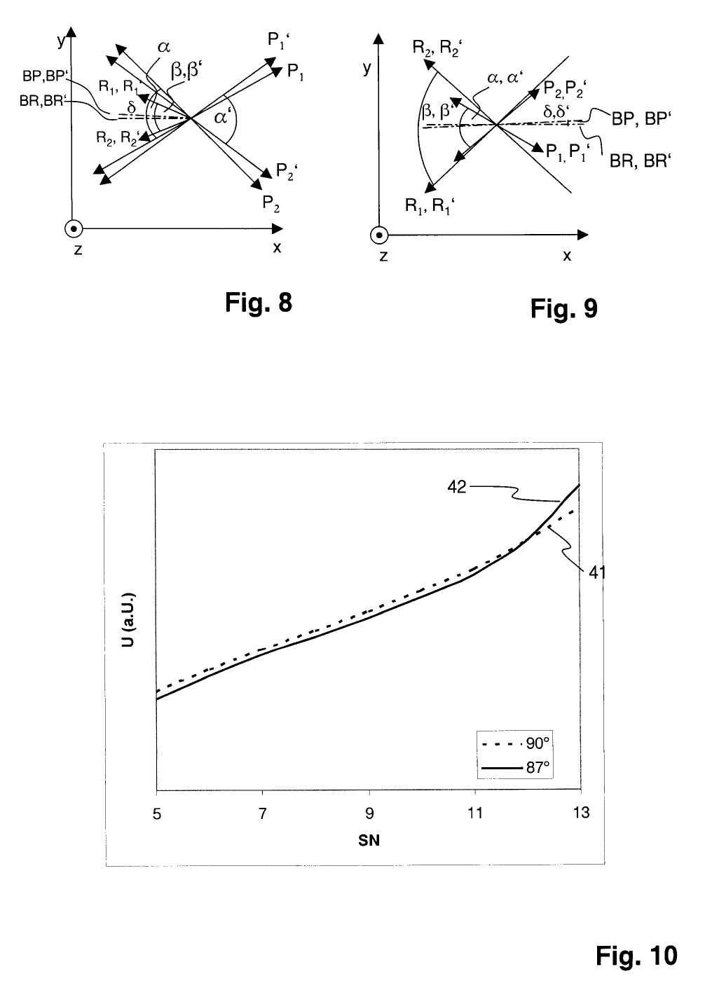

FIG. 8 shows the different directions and orientations within the double cell according to the two last mentioned preferred embodiments of the invention. As opposed to FIG. 7 an X-buffed LTN arrangement is shown in FIG. 8. Hereby the directions and orientation layers of the substrates 32, 34 and of a third polarizer 35 are orientated according to the directions of the first liquid crystal cell 20 as follows.
The orientation R2′ of the third orientation layer 32 being at least approximately directed in the same direction as the orientation R2 of the second orientation layer 24.
The orientation R1′ of the fourth orientation layer 34 being at least approximately directed in the same direction as the orientation R1 of the first orientation layer 22.
The orientation P1′ of the third polarizer 35 being at least approximately parallel to the orientation P1 of the first polarizer 21.
The orientation P2′ of the fourth polarizer 31 being at least approximately parallel to the orientation P2 of the second polarizer 25.
The orientation P2 of the second polarizer 25 being uncrossed in relation to the direction P1 of the first polarizer 21 at an angle of α<90°, in particular 82°<α<89°. P1 is thus not perpendicular to P2.
For the shown design with four polarizers: the orientation P1′ of the third polarizer 35 is also uncrossed in relation to the direction P2′ of the fourth polarizer 31, therefore P1′ is not perpendicular to P2′. Hereby the respective two direction pairs, which were described as “at least approximately parallel”, such as e.g. P1 and P1′ are deliberately shown twisted in relation to one another. The mutual twist is e.g. smaller than ±20°. This applies for the mutual twist of the orientation layers as well as also for the mutual twist of the polarizers.

For the design with three polarizers (not shown) it would analogously apply, that the arrangement P1′ of the third polarizer 35 is uncrossed in relation to the direction P2 of the second polarizer 25, therefore P1′ in this case is not perpendicular to P2.

FIG. 9 shows a preferred embodiment basing on two X-buffed TN cells, in which, within the scope of the corresponding production tolerances, the following applies.
The orientation R2′ of the third orientation layer 32 is directed in the same direction as the orientation R2 of the second orientation layer 24.
The orientation R1′ of the fourth orientation layer 34 is directed in the same direction as the orientation R1 of the first orientation layer 22.
The orientation P1′ of the third polarizer 35 is parallel to the orientation P1 of the first polarizer 21.
The orientation P2′ of the fourth polarizer 25 is parallel to the orientation P2 of the second polarizer 31.
The orientation P2 of the second polarizer 25 uncrossed in relation to the direction P1 of the first polarizer 21 at an angle of α<90°, in particular 82°<α<89°.
For the shown design with four polarizers: the orientation P1′ of the third polarizer 35 is uncrossed in relation to the direction P2′ of the fourth polarizer 31 at an angle of α<90°, in particular 82°<α<89°. P1′ is therefore not in perpendicular to P2′. For the design with three polarizers, in which the second polarizer 25 is identical to the fourth polarizer 31 (not shown), it would analogously apply, that the orientation P1′ of the third polarizer 35 in relation to the direction P2 of the second polarizer 25 is uncrossed, P1′ is therefore not perpendicular to P2.

The configuration shown in FIG. 8 uses two cells of the type X-buffed LTN, the configuration shown in FIG. 9 uses two cells of the type X-buffed TN. The above details also respectively apply for P-buffed and TN or LTN types, in order to create a double cell according to the invention.

In order to create a light shutter according to the shown preferred embodiments of the invention from a conventional filter used for protective filters for welding, the two polarizers associated with a particular liquid crystal cell must consequently be uncrossed in relation to one another. This may e.g. be achieved by
twisting each of the outer polarizers 21, 35 in the direction of the bisector BR, BR′ by 90°-α in relation to one another,
or alternatively by twisting one middle polarizer or both middle polarizers in the direction of the bisector BR, BR′ by 90°-α
or by twisting all (i.e. three or four) polarizers in relation to the usual orientation, in a manner that the resulting angle between the polarization directions of each of the outer polarizers 21, 35 and the one middle polarizer 25—or the respective allocated one of two middle polarizers 25, 31 respectively—is 90°, in particular 82°<α<89° and wherein furthermore the respective bisectors BR and BP as well as the bisectors BR′ and BP′ are only twisted a little in relation to one another, i.e. 0°<δ,δ′<20°.

This results in a particularly good compensation of the mentioned darker regions of the one cell with lighter regions of the second cell and vice versa. With the special requirement within the individual liquid crystal, i.e. that δ,δ′ are relatively small, e.g. δδ′<45°, it is achieved that the angle regions of the “best viewing direction” are darkened more strongly. With the special requirement for arrangement of the two liquid crystal cells, i.e. that the cells are substantially arranged in point symmetric manner, it is achieved that the lighter zones of the one cell are compensated with the darker zones formed in this manner in the other cell.

In a further preferred embodiment of the invention, only one of the two cells is uncrossed. In this design an asymmetrical dependency on angle of view is achieved, which can be interesting for eye protection, as the vertical field of vision of the eyes is significantly smaller towards the top than towards the bottom. Thus in this embodiment one cell is preferably orientated such that the “best viewing direction” faces downwards. This cell is designed to have uncrossed polarizers. The other cell is a standard cell with crossed polarizers, the “best viewing direction” of which faces upwards. Hereby the “best viewing direction” of a cell faces approximately in the direction of the bisector BR of the allocated orientation layer.

The cells of the embodiments presented hitherto are advantageously of the type “twisted nematic” (TN) with a twist, i.e. with an angle β between the orientation layers, between 70°<β<110°, wherein the direction of the twist in the one cell is opposed to the direction in the other cell.

In a further preferred configuration the uncrossed cell or cells of the hitherto presented embodiments are “low twisted nematic” (LTN) cells with a twist of approximately 80° and preferably 70°<β<85°.

In a preferred configuration, the uncrossed cell or cells are so-called X-buffed buffed cells, i.e. cells in which the orientation layers are twisted by approximately 90° in relation to the polarization directions of the respective proximate polarizer.

In a preferred configuration, the filter 2 consists of two symmetrical cells 20, 30, which are both of the uncrossed type. They are preferably both controlled with the same voltage and through the same control electronics 5. The at least two liquid crystal cells are also connected with the same input voltage source.

FIG. 10 shows a course of a voltage-darkening dependency. Hereby the darkening SN (“shade number”) is plotted along the abscissa through a filter in dependency of the amplitude U of the control voltage. For crossed polarizers, i.e. with α=90° a first curve 41 is formed. For uncrossed polarizers, in the present exemplified case with α=87° a second curve is formed, which deviates to a considerably higher degree from an ideal linear correlation.

The curve is typical for a double TN cell designed and arranged to be mirror inverted in the X-buffed design with four polarizers, in which within the manufacturing tolerances the polarization direction P1 coincides with P2 and P1′ with P2′ as well as the rubbing directions R1 with R1′ and R2 with R2′. Depending on the embodiment, desired protection levels and chosen components, the non-linearity is more or less pronounced, in some cases it may be omitted (e.g. if the filter from FIG. 10 is only operated up to protection level 11).

The cells are generally controlled by means of a square wave voltage symmetrical around the zero point. Typical frequencies of the square wave signal are 50 Hz, may, however be as low as 1 Hz or less for power saving filters.

Preferably overall mirror inverted LTN liquid crystal cells are arranged in the X-buffed configuration with altogether four polarizers, in which the characteristic angle δ is at least approximately zero and in which the polarization direction P1 coincides with P2 and P1′ with P2′ as well as the friction directions R1 with R1′ and R2 with R2′.

Despite the possibly non-linear voltage-darkening characteristics, achieve linear overall characteristics regarding a user setting or a control signal, the control features a non-linearity for compensation. In the simplest case this is e.g. a non-linear scale of the setting of an input means operated by the user, e.g. an adjusting knob or a sliding controller. In a different embodiment of the invention the input voltage is formed by digital or analogue electronics, which has a stored compensation characteristic. The compensation characteristic is formed to be inverse in relation to the voltage-darkening characteristic, such that the serial connection of the compensation characteristic with the voltage-darkening characteristic results in a linear curve.

The liquid crystal cells may, apart from the conventional TN or STN LC-mixtures, also contain guest-host LCs. The cells may be prepared such that a low anchoring energy of the molecules at the orientation layer is achieved, such as is e.g. described in European patent application 06 405 072 of the same applicant.

The cells may also be combined with other components, e.g. with additional cells filled with guest-host LC-mixtures, or further TN cells.

Reference list
1 glare protection cartridge
2 filter
3 protecting shield
4 protective mask
5,5′ control, voltage source
20 first liquid crystal cell
21 first polarizer
22 first orientation layer
23 interspace with liquid crystal layer
24 second orientation layer
25 second polarizer
30 second liquid crystal cell
31 fourth polarizer
32 third orientation layer
33 interspace with liquid crystal layer
34 fourth orientation layer
35 third polarizer

1. Electro-optical glare protection filter (2) comprising.
at least two liquid crystal cells (20, 30) of the type “twisted nematic” (TN) arranged in succession, with polarization layers (21, 25, 31, 35), wherein the polarization directions of two respective polarization layers (21, 25, 31, 35), which are allocated to one respective liquid crystal cell (20, 30), are respectively twisted in relation to one another by at least 45° and
a control means (5, 5′) for electrical control of the liquid crystal cells (20, 30),
wherein
the polarization direction of two polarization layers (21, 25, 31, 35), which are allocated to one respective liquid crystal cell (20, 30) are uncrossed, i.e. twisted in relation to one another by an angle different from 90°.

2. The electro-optical glare protection filter (2) according to claim 1, comprising at least two liquid crystal cells, wherein
in precisely two of these liquid crystal cells (20, 30) the polarization directions of the two polarization layers (21, 25; 31, 35), which are allocated to the respective liquid crystal cell (20, 30) are uncrossed.

3. The electro-optical glare protection filter (2) according to claim 2, wherein in the cell or cells, which comprise uncrossed polarizers, the angle between
the bisector of the acute angle between the polarization directions of the uncrossed polarizers (21, 25; 31, 35) and
the bisector of the allocated liquid crystal layer (23, 33) is less than 45°.

4. The electro-optical glare protection filter (2) according to claim 2, wherein the two liquid crystal cells (20, (30)) are at least approximately mirror symmetric to one another in their design, wherein it applies in particular that the glare protection filter, in the following order, comprises:
a first polarizer (21)
a substrate with a first orientation layer (22),
an interspace with a liquid crystal layer (23),
a substrate with a second orientation layer (24),
a second polarizer (25),
a fourth polarizer (31), which may be identical to the second polarizer (25),
a substrate with a third orientation layer (32),
a further interspace with a liquid crystal layer (33),
a substrate with a fourth orientation layer (34),
a third polarizer (35),
wherein
the orientation R2′ of the third orientation layer (32) is at least approximately directed as the orientation R2 of the second orientation layer (24);
the orientation R1′ of the fourth orientation layer (34) is at least approximately directed as the orientation R1 of the first orientation layer (22);
the orientation P1 of the third polarizer (35) is at least approximately parallel in relation to the orientation P1 of the first polarizer (21);
the orientation P2′ of the fourth polarizer (31) is at least approximately parallel in relation to the orientation P2 of the second polarizer (25);
the orientation P2 of the second polarizer (25) is uncrossed in relation to the direction P1 of the first polarizer (21) at an angle α<90°, in particular at 82°<α<89°;
the orientation P1′ of the third polarizer (35) is in relation to the direction P2′ of the fourth polarizer (31) uncrossed at an angle α<90°, in particular 82°<α<89°.

5. The electro-optical glare protection filter (2) according to claim 4, wherein
the orientation R2′ of the third orientation layer (32) is directed as the orientation R2 of the second orientation layer (24);
the orientation R1′ of the fourth orientation layer (34) is directed as the orientation R1 of the first orientation layer (22);
the orientation P1′ of the third polarizer (35) is parallel to the orientation P1 of the first polarizer (21);
the orientation P2′ of the fourth polarizer (31) is parallel to the orientation P2 of the second polarizer (25).

6. The electro-optical glare protection filter (2) according to claim 1, wherein the twist between the polarization directions of two respective uncrossed polarization layers 21, 25, 31, 35) is 82° to 89°, preferably 85° to 88°, wherein the acute angle between the polarization directions is measured.

7. The electro-optical glare protection filter (2) according to claim 1, wherein the liquid crystal cells (20, 30) are “X-buffed” cells, i.e. that the orientation layers are respectively twisted by between 70° and 90° in relation to the polarization directions of the respective proximate polarizers (21, 25, 31, 35).

8. The electro-optical glare protection filter (2) according to claim 3, wherein the bisector of the acute angle between the polarization directions of two uncrossed polarizers (21, 25, 31, 35) coincides with the bisector of the allocated liquid crystal layer (23, 33) arranged between these polarizers.

9. The electro-optical glare protection filter (2) according to claim 3, which comprises no retarder layers or compensation layers for compensation of a double refraction in at least one liquid crystal layer (23, 33).

10. The electro-optical glare protection filter (2) according to claim 1, wherein the liquid crystal cells (20, 30) are of the type “twisted nematic” (TN) with a twist between 70° and 110° and the twist in the one cell (20) is opposed to the twist in the other cell (30).

11. The electro-optical glare protection filter (2) according to claim 7, wherein one or both of the liquid crystal cells (20, 30) are of the type “low-twisted nematic” (LTN) with a twist between 10° and 85° and preferably between 70° and 85°.

12. Method for operation of an electro-optical glare protection filter (2) according to claim 1, comprising the step of controlling said at least two liquid crystal cells (20, 30) with the same control voltage.

13. Method for operation of an electro-optical glare protection filter (2) according to claim 1, comprising the step of compensating a non-linearity in the voltage-darkening ratio of at least one liquid crystal cell (20, 30) by a non-linearity of the control means (5).

14. Glare protection unit (1) for a portable glare protection device (4), wherein the glare protection unit (1) comprises an electro-optical glare protection filter (2) according to claim 1.
